(19) United States
(12) Patent Application Publication
(10) Pub. No.: US 2026/0280857 A1
(43) Pub. Date: Sep. 17, 2026

(54) TECHNIQUE FOR SHARING A DIGITAL KEY

(71) Applicant: Bayerische Motoren Werke Aktiengesellschaft, Muenchen (DE)

(72) Inventor: Matthias FINK, Muenchen (DE)

(21) Appl. No.: 19/531,837

(22) Filed: Feb. 6, 2026

(30) Foreign Application Priority Data
Feb. 7, 2025 (DE) 10 2025 104 625.5

(51) Int. Cl. H04L 9/08; H04L 9/32

(52) U.S. Cl. CPC H04L 9/085; H04L 9/32

(57) ABSTRACT

A method for sharing a digital key includes receiving a request for key sharing; in response to receiving the request, checking a current context of the digital key; and sending an acknowledgement for the request based on the checking.

### CROSS REFERENCE TO RELATED APPLICATION

This application claims priority under 35 U.S.C. § 119 from German Patent Application No. 10 2025 104 625.5, filed Feb. 7, 2025, the entire disclosure of which is herein expressly incorporated by reference.

### BACKGROUND AND SUMMARY

The invention concerns a technique for sharing a digital key, in particular for delegated key sharing. The invention is intended for implementation in a central vehicle manufacturer server, a key tracking server, an application for a terminal of a vehicle user, and an application for a terminal of a service provider.

It is known that a terminal, for example, a smartphone, can be used to store a digital key, for instance in a secure memory of the device. Use of the key is based on interfaces between the secure memory and an operating system of the device, and also between the operating system and other applications (apps) that are executed on the device.

With Digital Key Release 3, the Car Connectivity Consortium (CCC) defines a standard for a digital vehicle key in the form of a technical specification. Corresponding digital keys are increasingly being used in addition or as an alternative to conventional vehicle keys such as key fobs.

In this regard, for instance a terminal may have an application or app of a vehicle manufacturer, or of a service provider, installed on it that allows access to the vehicle by means of a digital vehicle key held on the device, allows certain vehicle functions to be controlled, etc. Extended possibilities for use also arise from the existence of a backend system for key management, i.e., management or administration of the digital vehicle key.

A digital key or vehicle key can be created, for example, by pairing a terminal with a vehicle. In a CCC context, this is called owner pairing. A prerequisite for this is that a proof of ownership is supplied to the vehicle, e.g., by presenting two key fobs at the same time.

A digital key can also be passed from one device to another (key sharing), for example, from one user to another user (for instance in a private use case), from a backend to a user (for example, in a commercial-server-to-user use case), from a user to a backend (in the case of a so-called service activation as specified by the CCC) or from backend to backend. Corresponding signaling, for example, according to the CCC, involves a terminal or multiple terminals, a device manufacturer server, a vehicle manufacturer server and the vehicle, and also possibly a service provider server for server based key sharing.

When a natural person passes a digital key to a backend, key sharing is often performed on the basis or as part of a contract with a service provider. By way of example, the service provider may be a workshop company with which the person wants to have their vehicle serviced or repaired. The service can generally be provided via a backend, i.e., on a server or by multiple servers. For example, the backend can provide routines for reserving a workshop appointment and for digital key sharing, the latter so that the workshop has access to the vehicle during the appointment.

Early CCC specifications define two roles for digital keys (in respect of the users thereof): The key for the owner, or owner key, has full or unrestricted rights or permissions, both in terms of access to the vehicle and in terms of driving the vehicle, and can perform key sharing to share a digital vehicle key for a trusted person or friend or to forward the digital key to the applicable person (or the terminal of that person). Such assigned or forwarded keys usually have only limited permissions, for example, allow only access to the vehicle (but not driving), or driving only with reduced engine power, etc. A shared key cannot be shared again.

With Release-4, the CCC introduced an extended concept for repeated key sharing (sharing in a chain) that also allows key sharing configurable on multiple levels. Different configuration options can be assigned to a shared key, for example, in regard to key management; for example, a key having appropriate management rights can manage, e.g., erase, other keys, even if they have not been directly or indirectly shared, or the key can hand down such management rights. Options in regard to visibility can include a key being able to see all other keys, not just the keys that are derived or reshared from that key. Options regarding shareability can include sharing between user accounts or only allowing sharing between different devices associated with a user account (or no additional sharing at all).

Based on these options, different roles can be defined. For example, an “owner” can manage all other keys, can reshare management or administrative rights, can see all other keys, and can share indefinitely. An “administrator” or “admin” can manage all keys except the owner key, can reshare/cannot reshare administrative rights, can see all other keys, can share indefinitely/can only share within the account. A member of a “family” can see all other keys, can share indefinitely/can share to a limited extent/can only share within their own account. A “guest” can only share within the account/cannot share at all. A role can also be defined for a service and the service can then act within the rights that have been assigned to or shared with it. In principle, a service could therefore also act as an administrator, share with other accounts, etc. In most cases, a service will be allowed to share only within its account or not at all.

A backend that has a key for a vehicle is referred to as an SBOD (Server Based Owner Device) or SBFD (Server Based Friend Device). An SBOD is a root element of a key sharing tree, and is thus a kind of equivalent to a natural person who has performed owner pairing with their terminal. By way of example, an SBOD can be used for integrating a vehicle into a vehicle fleet. For key sharing, the SBOD interacts with a rental company or fleet provider.

An SBFD, on the other hand, is directly or indirectly shared by an owner (a natural person or a backend). The SBFD is tied to a service provider, which interacts with the SBFD for key sharing. Customers of the service provider may be involved too, for example, in the case of a car sharing service, a workshop, etc.

An SBxD (SBOD or SBFD) follows the same rules as other digital keys; however, an SBxD cannot usually exercise its rights itself, but can only pass on or hand down these rights to a shared (an assigned), forwarded, derived key, etc.

More specifically, SBODs require proof of ownership to create them. This can be supplied, e.g., by a fleet operator in different ways. An SBFD can be implemented by means of standard key sharing (according to the standardized CCC protocol) with a backend (service provider and/or vehicle manufacturer). Alternatively, an SBFD service can be created in the backend in response to receipt of an applicable request. The request is processed in the backend on a proprietary basis (depending on the vehicle manufacturer, service provider, etc.). By way of example, an applicable request (Service Management Request) can be received in a vehicle manufacturer server.

When a customer performs a service activation, i.e., delegates (a right to) key sharing to a service in the backend (backend service or SBFD service), authorized persons of the relevant service provider can requisition key sharing for the vehicle at any time. However, further key sharing is possible indefinitely in principle, and so there are trust issues, or the issue of possible security holes, etc. This already applies to a service activation that is performed immediately before an appointment (e.g., at a dealership, workshop, etc.) and that is terminated immediately afterwards. However, security issues arise even more when the customer wants to use a service for a longer (or unlimited) period of time, e.g., because it seems inconvenient that the service has to be reactivated for each additional appointment.

An object underlying the present invention is to provide an improved technical concept for key sharing, in particular, but not only, delegated key sharing. The invention achieves this object by means of the subjects of the independent claims. Dependent claims provide preferred embodiments.

A first aspect of the present invention concerns a method for sharing a digital key. The method may be implemented, for example, in a backend server such as a central vehicle manufacturer server and/or a service provider server, and may be integrated, for example, in an inherently known functionality of an SBFD. The method comprises receiving a request for key sharing; in response to receiving the request, checking a current or present context of the digital key; and sending an acknowledgement for the request based on the checking.

In embodiments of the invention, the digital key may be a vehicle key. By way of example, in the case of delegated key sharing, such as server based key sharing, the digital key may be associated with an SBFD or an SBFD service. Further key sharing is then also referred to herein as delegated key sharing.

In embodiments of the invention, the context of the digital key is understood very comprehensively or generally, and can comprise, for example, a multiplicity of parameters, variables, tags or TLV (Tag Length Value) data or structures that directly or indirectly relate to, concern, etc., the key or service. The context may be variable over time, and so the current context concerns present or current values of context parameters, etc., as described herein. In some embodiments, key sharing is restricted to a current event, i.e., to a present or currently ongoing event. Requests for key sharing before or after an event are denied.

In some embodiments, the context can comprise a sharing restriction to reduce, restrict, limit, etc., key sharing. The sharing restriction can comprise a parameter, tag, etc., or can comprise multiple parameters, variables, etc., where applicable also nested or otherwise hierarchically structured. A specific value of the sharing restriction may or can be predefined, for example when creating a service, digital key, etc., and/or can apply, be defined or set, etc., individually for (at least) one event. By way of example, the value may be preset and progressively dynamically adjusted, as described herein. The same applies if the sharing restriction comprises multiple values that may be predefined or preset (for example, by means of default values) and/or that can be individually (re)defined, set differently, etc.

In certain embodiments, the sharing restriction can reduce, restrict or limit key sharing on an event-related basis. In some of these embodiments, key sharing is restricted to a current (present, currently ongoing) event, and this effect is conveyed by the sharing restriction. The sharing restriction can comprise, for example, a time (for example, in the form of a timestamp) for a start and/or an end of an event or appointment, a duration, or an implicit temporal extent (for example, stating a calendar date can define an event that lasts 24 hours).

An event may be defined by one or more statements in the context of the digital key, an applicable (for example, server based) service, etc., or can be defined implicitly, for example, by stating a start time and an end time (or a duration). In some embodiments, key sharing can take place only on an event-related basis, i.e., during an ongoing event, and that means that if at least one event is not defined at least implicitly (i.e., at least one temporal extent must be defined implicitly), no key sharing can take place. If one event is defined, no key sharing can take place before or after the event. If multiple events are defined (for example, an annually recurring maintenance appointment), no key sharing can take place between these appointments. If key sharing is supposed to be made possible, for example, for an unscheduled workshop visit, this requires an applicable event to be defined (as described herein).

In some of these or other embodiments, key sharing during an event defined in the context of the digital key is possible without restriction. In yet other embodiments, the sharing restriction is event-related in such a way that the sharing restriction limits key sharing during an event, i.e., the sharing restriction comprises, states or defines a maximum number of permissible key shares for an event. This (maximum) number may always be the same for all events in the context of a given key (i.e., a fixed value is always stated or specified as the number of permissible key shares), or the number may be specified for certain kinds or types of event, or for a given customer, service provider, vehicle type, etc.

When a number of permissible key shares is specified, this number may be firmly specified or may be specified in the form of a default value, for example, that can be changed for an individual event, multiple events, an event type, etc. By way of example, a default value may be zero, i.e., initially, when an event is defined, key shares are initially not permissible or possible at all. An adjustment, or selection of a non-zero value, can then be performed subsequently.

In some of these or other embodiments, the sharing restriction can concern a configuration or permission or multiple permissions of the shared key. By way of example, a sharing restriction can stipulate that a key shared directly by a service can continue to perform key shares (for example, until a maximum number of key shares according to the specification of the sharing restriction is reached), but the or any further key reshared by the directly shared key cannot itself perform any further sharing.

In some embodiments, the checking comprises ascertaining that an event has finished; and, based on the ascertainment, setting the sharing restriction to zero (insofar as the sharing restriction relates to a maximum permissible number of key shares).

In some embodiments, event-related context is defined in two separate steps or processes. First, for example, a service activation involves context, for instance a sharing restriction, which in this case, for example, is set to a generic value or default value (for instance zero), or to multiple such values (for example, time statements can initially be set to “from 00:00” and “to 23:59”), being defined or provided generally.

Not until in a second routine can context values, for example, specific, individual values, be stated, defined, etc., for an individual event. Dynamic setting of individual values in this manner can be performed by the user. By way of example, the user (vehicle user) can be presented with suggestions, for example, appointment suggestions, and the user can select one of the suggestions.

Some of these embodiments thus comprise receiving event-related context (for example, from an owner and regarding an individual event); and providing an event having the received context. By way of example, the providing can comprise setting the sharing restriction for the individual event as agreed, consented to or approved by the owner (or administrator). The received context can contain specific values and/or can represent the key holder's agreement to one or more default values.

Some embodiments can comprise forwarding a sharing restriction. By way of example, the sharing restriction can be delivered to a key tracking server to register the event there in respect of the key tracking server checking or enforcing the restrictions imposed by the sharing restriction.

In some embodiments, the checking also comprises receiving a sharing identifier, for example, a sharing URL; in response to receiving the sharing identifier, checking whether the sharing identifier is associated with a current event; and, based on the checking, selectively terminating key sharing.

Certain embodiments comprise subsequently receiving a request to finish an event (for example, from an employee of a service); and, in response to the received request, at least one of the following: terminating an uncalled sharing identifier, terminating a shared key that has resulted from key sharing.

A second aspect of the present invention also concerns a method for sharing a digital key. By way of example, the method may be implemented in a backend server such as a key tracking server. The method comprises receiving a request for registering an event; receiving a request regarding tracking a key shared from the digital key; in response to receiving the request, checking a sharing restriction associated with the registered event; and, based on the check, selectively terminating key sharing.

Some embodiments of this aspect of the invention comprise, in response to receiving the registration request, checking a signature and/or a user authentication regarding the sharing restriction associated with the event to be registered.

A third aspect of the present invention also concerns a method for sharing a digital key. By way of example, the method may be implemented in the form of an application on a terminal of a vehicle keeper or key holder (for example, owner). The method comprises providing event-related context, for example, a sharing restriction, for key sharing; requesting a signature for the provided context; and sending the context and the signature, for example, to a service provider server or central vehicle manufacturer server.

If the event-related context comprises a sharing restriction, the sharing restriction can restrict a specific or individual event (or multiple events), that is to say, for example, can state or define a start time, a duration and/or an end time, and/or can state or prescribe a maximum number of permitted or permissible key shares during the event.

In some embodiments of this aspect of the invention, the requesting is directed via a user interface (for example, a graphical user interface, an HMI (Human-Machine Interface), etc.) of the aforementioned terminal to a user, for instance a key holder. The requesting can comprise requesting a user authentication to approve the context, for example, an event-related individual sharing restriction.

A fourth aspect of the present invention one again concerns a method for sharing a digital key. By way of example, the method may be implemented in the form of an application on a terminal of a service provider, e.g., on a PC, a service terminal, or on a mobile device that is made available to an employee, or may be implemented in the form of a web application. The method comprises sending a request for key sharing; and receiving an acknowledgement for the request, the acknowledgement relating to an event-related sharing restriction for key sharing.

The acknowledgement can be received before or after a sharing identifier received in response to the request. The acknowledgement can represent a statement that the requested key sharing is not possible because there is no approved sharing restriction, there is no active event and/or the maximum number of key shares for the event has been reached. The method can also comprise, in response to the received acknowledgement, terminating the method.

Yet another aspect of the present invention concerns a backend server, in particular a central vehicle manufacturer server (or a service provider server), designed for carrying out a method according to the first aspect of the invention as described herein.

Another aspect of the present invention concerns a backend server, in particular a key tracking server, designed for carrying out a method according to the second aspect of the invention as described herein.

Another aspect of the present invention concerns a computer program product comprising program code sections for carrying out a method according to the third aspect of the invention as described herein when the computer program product is executed on a computer. The computer program product may concern in particular an application or app for a terminal of a key holder, for instance a vehicle companion app (provided by a vehicle manufacturer) or an app of a service provider for placing orders, ordering, booking, reserving, etc.

Yet another aspect of the present invention concerns a computer program product comprising program code sections for carrying out a method according to the fourth aspect of the invention as described herein when the computer program product is executed on a computer. The computer program product may concern an application or app for a terminal of a service provider, a PC software or a desktop application for a PC or a service terminal, a web application, etc., or an app for a mobile device used by an employee of the service provider.

Yet another aspect of the invention concerns a terminal designed for carrying out a method according to the third or fourth aspect of the invention as described herein. The terminal has at least one secure memory for storing a (shared) digital key, the secure memory being involved in carrying out the method. The terminal may have a computer program product as described herein installed on it that interacts with the secure memory.

One aspect of the present invention concerns a system for sharing a digital key for a motor vehicle. The system comprises the motor vehicle, a central vehicle manufacturer server as described herein, a service provider server as described herein, and optionally a key tracking server as described herein. The system also comprises an application, for example in the form of a vehicle companion app or customer app as described herein (or a terminal on which this application is installed), and also an application, for example in the form of a service app or employee app as described herein (or a terminal on which this application is installed).

The invention will now be described in more detail with reference to the accompanying drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a first exemplary embodiment of an inventive system;

FIG. 2 illustrates a second exemplary embodiment of an inventive system;

FIG. 3A illustrates a flowchart for a first exemplary embodiment of an inventive method;

FIG. 3B illustrates a flowchart for a second exemplary embodiment of an inventive method;

FIG. 3C illustrates a flowchart for a third exemplary embodiment of an inventive method;

FIG. 3D illustrates a flowchart for a fourth exemplary embodiment of an inventive method; and

FIG. 4 illustrates a flowchart for a fifth exemplary embodiment of an inventive method.

### DETAILED DESCRIPTION OF THE DRAWINGS

A terminal is understood herein to mean any device at or on which electronic communication, a communication network, etc., comes to an end and that is trained for use, operation, etc., by a human user, a person, an operator, a service employee, etc., for example, by means of a user interface such as an HMI (Human-Machine Interface), a GUI (Graphical User Interface), etc. By way of example, a terminal may be a mobile device, a portable device, a wearable, etc., such as a notebook, tablet or smartphone, a smartwatch, a smart band, a smart ring, etc. Devices for stationary use, such as a PC, a service terminal, an operating console, etc., are also regarded as terminals.

Where the expression “a terminal” is used for short, the intention is also to include situations in which a terminal having at least one peripheral component is used, such as a mobile device having a smart card or other hardware token. A “terminal” may also mean a device that is available only in the future, provided that it has the necessary processor capabilities, memory capacities, etc., for implementing an inventive aspect described herein.

A terminal can have a secure memory or environment, a secure element, etc., for example, based on an applicable chip, a crypto processor, etc. By way of example, the secure memory can comprise at least one HSM (Hardware Security Module), TPM (Trusted Platform Module), a secure element (Secure Enclave), a TEE (Trusted Execution Environment), etc., or combinations thereof. A secure memory may be designed for saving or storing at least one cryptographic, electronic or digital key. By way of example, a secure memory may be designed for storing at least one cryptographic or digital vehicle key, the latter being able to be stored for example in the form of an endpoint according to the CCC.

Where the text herein refers to a URL (Uniform Resource Locator) for short, this is generally intended to be understood to mean an allocation reference, which may also be, for example, a link, pointer, URI (Uniform Resource Indicator), etc.

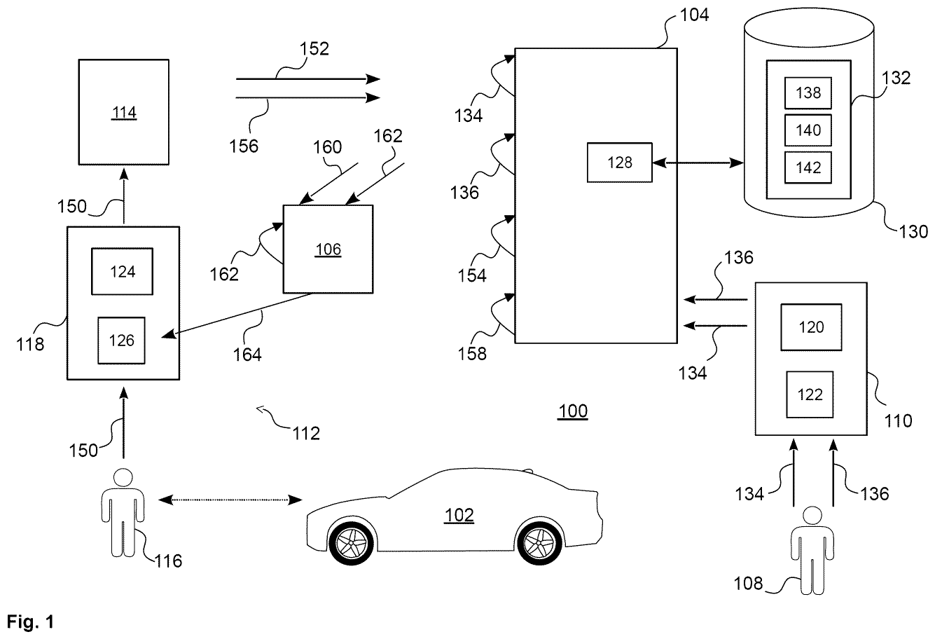

FIG. 1 uses a schematic diagram to show a system 100 having a motor vehicle 102 and servers 104 and 106 in an onboard backend for the vehicle 102. A user or keeper 108 of the vehicle 102 uses a terminal 110. A service provider 112 operates a server 114 at the service provider end. An employee 116 uses a terminal 118 provided by the service provider 112.

The servers 104 and/or 106 can be operated by a manufacturer of the vehicle 102. By way of example, the server 104 can implement a central vehicle manufacturer server (vehicle OEM (Original Equipment Manufacturer) server) in a CCC context. By way of example, the server 106 can implement a key tracking server (KTS) for backend or vehicle-level key management in a CCC context.

The user 108 may be the owner or another keeper or joint user of the vehicle 102. They are also a customer of the service provider 112, as described below, and therefore, to facilitate understanding, occasionally the expression keeper 108 of the vehicle 102 or customer 108 of the service provider 112 is used, and this means the same natural person.

An application 120 for device-level key management is installed on the terminal 110 of the vehicle keeper 108, for example, a vehicle companion app provided by the vehicle manufacturer for this purpose. The terminal 110 has a secure memory 122 that can be used to hold digital vehicle keys for the vehicle 102. The app 120 is qualified to manage these keys in the secure memory 122.

In the example described here, the service provider 112 is a workshop business. The service provider server 114 can be operated either by the service provider 112 itself or, for example, by an operator (for example, the vehicle manufacturer), which also operates the servers 104 and/or 106.

The employee 116 may work as a car mechanic, vehicle mechatronics engineer, vehicle service technician or the like for the service provider 112. The terminal 118 provided by the service provider 112 may be, for example, a smartphone or tablet on which a service application or service app 124 for workshop-related key management is installed. The terminal 118 has a secure memory 126 that can hold a shared digital vehicle key for the vehicle 102, as described below. The app 124 is qualified to manage the key in the secure memory 126.

As mentioned, the vehicle keeper 108 is a customer of the service provider 112. In this regard, the keeper or customer 108 uses the app 120 to perform a service activation in order to grant a (SBFD) service 128, which is instantiated by the service provider server 114, a right to key sharing. In other words, the customer 108 delegates (a right to) key sharing to the service 128 in the backend (referred to as the backend service, or SBFD service, for short). Even if this service 128 is said to reside in or on the service provider server 114, all or some functionalities associated with the SBFD service may also reside on the central vehicle manufacturer server 104.

In the example described here, “delegated key sharing” should be understood to mean that authorized persons at the premises of the service provider 112 (for example, the employee 116 using the application 124 on their terminal 118) can requisition key sharing for the vehicle 102 at any time in order to gain access to the vehicle 102 to work on a job, etc.

Even if the customer 108 performs a service activation immediately before an appointment with the service provider 112 (e.g., workshop appointment) and terminates it immediately afterwards, there are already trust issues, security issues, etc., because further key sharing by means of the SBFD service 128 is possible indefinitely during the appointment. Security holes are even more likely to exist if the customer 108 wants to use the service 128 for a longer period of time, e.g., for years during the validity of a contract or, in general, a relationship with the service provider 112, e.g., because it seems inconvenient that the service is supposed to be reactivated for each additional appointment. From the customer's point of view, it instead seems more convenient if an icon concerning the service provider 112 is constantly displayed in a wallet of the terminal 110 or directly in the vehicle 102. However, the SBFD service 128 is then available indefinitely for delegated key sharing, and this is generally unsatisfactory from a security point of view.

According to the invention, therefore, technical measures are proposed to close or minimize this security hole without, however, affecting convenience for vehicle keepers or customers, and thus to promote a relationship of trust between service providers and customers for the use of digital keys.

From a certain perspective (which should not be understood as limiting), the invention proposes defining a sharing restriction in order to restrict or limit key sharing, for example, delegated key sharing by means of a server based service, to specific events. The sharing restriction may be dynamically configurable, i.e., adjustable for different types of events, and can also change during an event.

In general or to put it another way, any requisitioning of (delegated) key sharing shall result in a context of the applicable service being checked, and a result of the checking is taken as a basis for key sharing being allowed or denied. A context to be checked can comprise the aforementioned sharing restriction, for example, a current value (i.e., a value in force at the time of the check) of the sharing restriction, but can also, additionally or alternatively, comprise other aspects, concerns, matters, content of the service (i.e., parameters, variables, tags, etc.), as described herein.

Taking into account a (current) context of the service can improve a general level of security for delegated key sharing.

A technical background and the general meaning of terms such as “context” and “event” are familiar to those skilled in the art. In exemplary embodiments of the invention, an event has a duration, a start time and/or an end time. In some exemplary embodiments, a sharing restriction restricts key sharing to an ongoing event, i.e., any key sharing is possible only after the start time, before the end time, or over the duration of an event.

In these or other exemplary embodiments, a sharing restriction or sharing limit sets a dynamic, i.e., individually and/or progressively adjustable, restriction or bound (or such a limit) for a total or maximum permitted number of key shares. In these exemplary embodiments, the aforementioned restriction to the duration of the event can be implemented in such a way that the number of permissible key shares before and after the event is set to zero.

In general, the number of permitted key shares during an event can be configured in a variety of ways. However, when the event's end time is reached, the number of remaining permissible key shares for that event is set to zero. Key sharing is then no longer possible. The same applies if a service provider has already performed the number of permitted or permissible key shares before an event takes place. For further key shares, a customer would need to approve or agree to additional key shares. By way of example, this can be accomplished by means of a newly created event, or by expanding or modifying an event.

Referring again to the illustrative scenario in FIG. 1, the service provider server 114 holds the already mentioned SBFD service 128. To put it in general terms, a context 130 is used for any key sharing from the SBFD 128, or the context 130 is used to check whether the requisitioned key sharing is permissible, that is to say whether, for example, approval from the customer 108 has been obtained for this.

In order for key sharing to be permissible, there must be an event 132 in the context 130 of the service 128, i.e., an event 132 must be defined in association with the SBFD service 128.

One routine has involved the customer 108 performing a service activation by means of the app 120 (e.g., vehicle companion app or customer app of the vehicle manufacturer, or customer app of the service provider 112) in a preceding step 134, with the SBFD 128 being produced or instantiated. FIG. 1 illustrates the SBFD 128 not in the service provider server 114, but in the central vehicle manufacturer server 104, because data and technical functionality of the service 128 can also be hosted in the central vehicle manufacturer server, as described herein.

In an illustrative scenario, the SBFD service 128 will persist continuously after it has been created, i.e., the customer 108 will not perform deactivation even if there are no specific appointments or if a routine maintenance appointment is still in the distant future. From a technical point of view, an icon in a wallet on the terminal 110 can represent the service 128 (from the customer's point of view, such an icon conveniently represents the service provider 112). The service 128 may also be visible in the vehicle 102, similarly to a shared digital vehicle key.

Using this icon, the customer 108 now books an appointment, for example, a workshop appointment, for the vehicle 102 with the service provider 112 in a step 136 (but booking can also be performed in another way, for example, in an app provided by the service provider 112, the vehicle manufacturer or a third party). This appointment is saved as the event 132 in the backend 104. More specifically, the customer 108 uses their authorized digital key (owner or administrator), which is held in the secure memory 122 of the terminal 110, to give their consent or approval for the event 132, which in the example comprises at least a start time 138 and an end time 140, by means of a cryptographic signature. In this way, the start time 138 can be used, for example, to book an appointment to service the vehicle 102 days or weeks in advance. The end time 140 must also be stated or otherwise determined in order to deterministically finish the event 132 at a specific time. In other exemplary embodiments, it would also be possible for only a start time and a duration, or a fixed period of time, for example, an appointment prearranged for a precise day (or multiple days), to be stated or saved or to define the event 132 or be automatically used. A day-specific appointment may relate, for example, to the opening or workshop hours of the service provider 112.

In the example of FIG. 1, the event 132 also comprises a limit 142, or a maximum number of permissible shares, in order to generally minimize opportunities for the SBFD service 128 to be abused. The SBFD 128 saves the described information, i.e., the event 132 with at least the data 138, 140, 142, for future checks, as described below. It should be pointed out again that, additionally or alternatively, further context can be saved in association with the SBFD service 128 or used for checks, specifically both in addition to the event 132 (e.g., the context 130 could comprise other events in addition to the event 132) and as part of the event 132 (i.e., as an alternative or in addition to the definition of the event 132 by means of the start time 138, the end time 140 and the limit 142, a current status of the event could be maintained and checked, for example). By way of example, an artificial intelligence (AI), for instance in the form of an AI agent acting for the customer 108 or the service provider 112, could check key sharing requested for the SBFD 128 for plausibility and, to that end, for example, extensively consider a current context, for example, the current time, the requesting person, etc.

In the example of FIG. 1, the employee 116 of the service provider 112 is an authorized person and, in a step 150, requisitions key sharing by means of their terminal 118 (the key sharing could instead also be requested by means of a service terminal (not shown in FIG. 1), etc., for example, using a smart card). As a result of this, the backend 114 of the service provider 112 can check whether approval has been obtained, i.e., the requisitioned key sharing can be performed. From a technical standpoint, the service provider server 114 can initiate such a check in the central vehicle manufacturer server 104.

This check can comprise a first check 154, which can be performed before a standard routine for key sharing, for example, prior to a request 156 and creation of a sharing URL, and which can be prompted by the request 152 for key-sharing as soon as it arrives at the central vehicle manufacturer server 104. The further handling of the request 152 is immediately aborted in the backend server 104 if the check 154 on the basis of the context 130 associated with the SBFD 128 (which, in the example of FIG. 1, in particular comprises the event 132) reveals that key sharing is not permissible.

A second check 158 can be performed additionally or alternatively during the key sharing in progress, for example, as a result of the sharing URL having been called. The rest of the routine for key sharing is immediately terminated if approval for this key sharing has not been obtained at this time, for example, because the event 132 has already finished or the limit 142 would be exceeded.

Following preceding registration 160 of the event 132 with the key tracking server 106 (for example, during booking 136), a third check 162 on the current context 130 of the event 132 can also take place in the key tracking server 106. This means that enforcement of the inventive regulations (policy) for key sharing can be ensured (for example, acknowledgement of denial 164 of key sharing to the secure memory 126 of the service device 118) even if the backend (114, 104) should be compromised by the SBFD 128.

In general, a check on the context 130 with respect to the event 132 may reveal that the request 152 or the URL 154 is transmitted outside the period of time defined or provided for the event 132, and so key sharing is denied for that reason. In a simple exemplary embodiment, it is conceivable for this to terminate a context check, i.e., while the request 152 or the URL 154 is transmitted within the period of time intended for the event 132, key sharing is possible indefinitely.

In more complex exemplary embodiments, a check (154, 158 and/or 162) can ascertain whether the number of key shares adheres to the limit 142. The limit 142 can have a general value or an individually determined value. By way of example, a general value can be a plausible value that, for example, can be specified as a default value for certain types of appointment, events, etc., for example by the vehicle manufacturer, service provider 112, etc. The context 130, if and when relevant to checks 154, 158, 162, can be displayed to the user for approval on their terminal 110, for example, when booking 136.

If the service provider 112, i.e., the employee 116 and, where applicable, other employees, has finished work on the vehicle 102, the event 132 can be set to a defined status, for example “FINISHED” or the like, i.e., the event 132 can be marked accordingly, provided with a tag or flag, etc. This status causes any further request for key sharing by employees of the service provider 112 (including the employee 116) to be denied. Finishing the event 132 can also mean that any sharing URLs that may already have been generated but have not yet been called are erased. In addition or alternatively, all keys already shared by the SBFD 128 can also be erased or terminated.

Should the service provider 112 require a further shared key during the event 132 in progress, but the limit 142 has already been reached, an extension for the event 132 and/or an increase for the limit 142 would have to be explicitly confirmed or approved by the customer 108. If the event 132 is already marked as finished, the customer 108 must approve a new event. Any such approval may require a signature provided using the digital vehicle key (owner or administrator) of the customer 108.

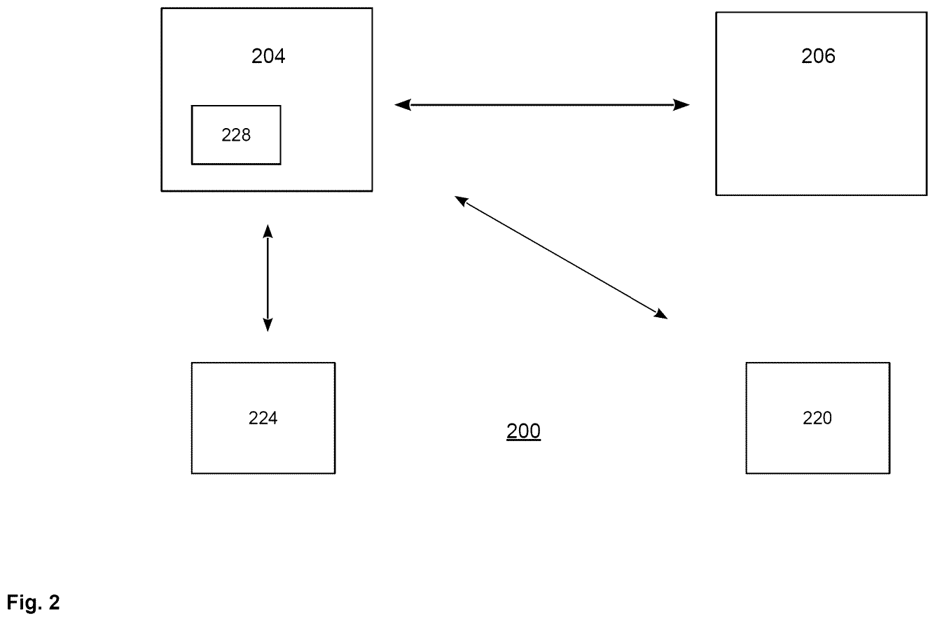

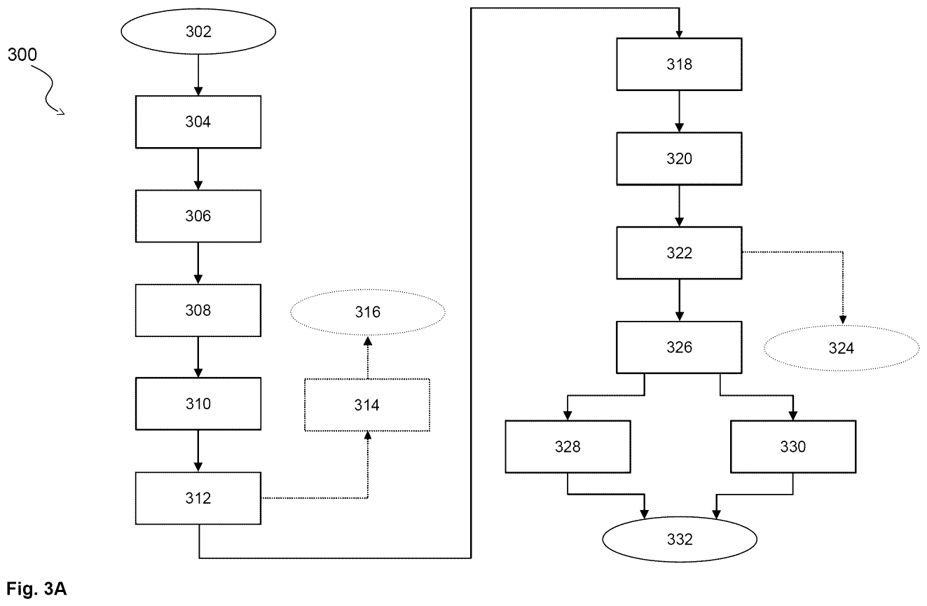

FIG. 2 uses a schematic block diagram to show another exemplary embodiment of a system 200 with a first backend server 204, a second backend server 206, a first application 220 and a second application 224. By way of example, the first backend server 204 represents a vehicle manufacturer server and/or a service provider server (so-called according to CCC nomenclature). By way of example, the second backend server 206 represents a key tracking server (so-called according to the CCC). By way of example, the first application 220 represents a vehicle companion app or an app of a service provider for a terminal of a customer who wants to book an appointment for their vehicle with the service provider. For reasons of clarity, the app 220 is therefore also referred to as the “customer app”. The second application 224 represents an “employee app” of the service provider, which is made available to an employee of the service provider for their work. The employee app may either be present on a mobile device and/or comprise an application such as a PC application for another terminal of the service provider, a web application, etc.

The components of the system 200 that are shown in FIG. 2 cooperate to control sharing of a digital key, in particular a vehicle key, in the inventive manner. The sharing preferably concerns delegated key sharing, particularly preferably server based key sharing, where the vehicle keeper has shared their key with a server (friend key according to the CCC), so that there is a virtual friend device on the server (i.e., there is an SBFD 228 on the server), which in turn has permission to share further keys. In other words, the vehicle keeper has delegated a right to key sharing to the server.

The SBFD 228 may be functionally, logically, etc., present on a server of a service provider, which is thus provided with the opportunity to generate keys to work on a job. It is conceivable for all or some functionalities that concern the SBFD 228, for example, including inventive functionalities described herein, to be provided in the central vehicle manufacturer server. By way of example, this can depend on whether a service provider operates its service provider server itself, or entrusts all or some of this to a vehicle manufacturer, etc. Exemplary embodiments of the invention are independent of these details, and therefore the system 200 in FIG. 2 makes no distinction between the service provider server and the central vehicle manufacturer server, but merely refers to the first backend server 204.

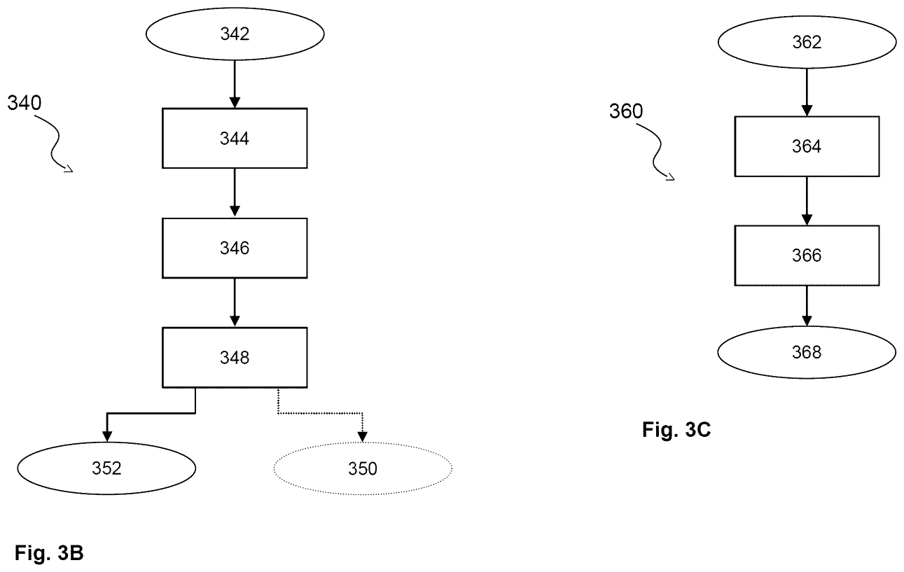

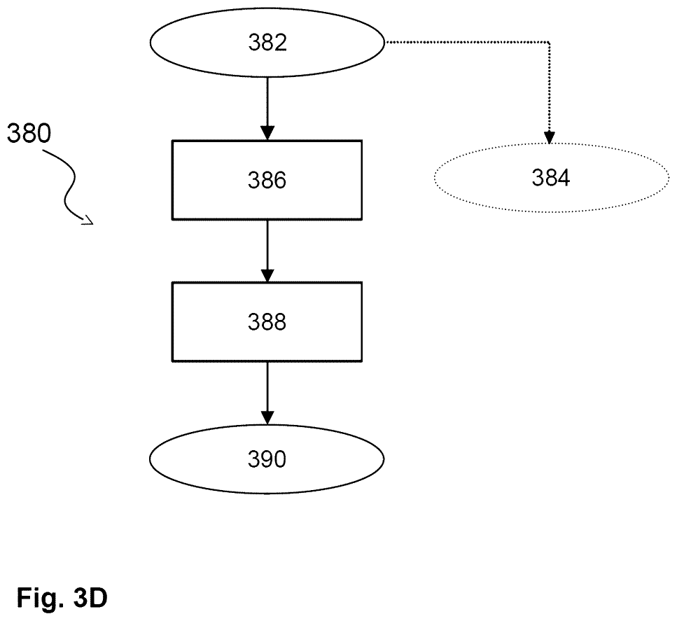

A specific routine for inventive key sharing in the system 200 will be described in more detail below with reference to the routines shown schematically in FIGS. 3A, 3B, 3C and 3D. In this case, FIG. 3A shows a routine for a method 300 for sharing a digital key in the first backend server 204. FIG. 3B shows a routine for a corresponding method 340 in the second backend server 206. FIG. 3C shows a routine for a corresponding method 360 in the first application or “customer app” 220. FIG. 3D shows a routine for a corresponding method 380 in the second application or “employee app” 224.

A routine in the method 360 in FIG. 3C begins in a step 362, for a service activation, with generation of a server based vehicle key being initiated on the first backend server 204, i.e., the SBFD 228 is instantiated. In a corresponding step 302 in method 300 in FIG. 3A, parameters and functionality for the SBFD 228 are provided in the backend server 204.

In a step 364 (method 360 in FIG. 3C), the customer app 220 provides a context for key sharing that is related to a specific event (booking, reservation, appointment, etc.). The event-related context can comprise a sharing restriction to reduce or limit key sharing. By way of example, the sharing restriction can generally restrict key sharing to a current event, i.e., reduce it to the duration of a temporally defined or limited event (i.e., no key sharing from the SBFD 228 is possible outside the time limits of the event). In addition or alternatively, the sharing restriction can restrict key sharing per event, i.e., there can be a limit to (a maximum number of) permitted key shares for an event. The limit may be firmly specified for certain types of event, for example, for a type of appointment (workshop visit, maintenance, parking assistance, etc.), for a type of service provider, there may be a limit per service provider, etc.

The sharing restriction may be defined by at least one of the following: a start time for the event, an end time for the event, a duration of the event (a duration may also be stated implicitly, for example, a statement indicating a day in the form of a calendar date can implicitly define an event with a duration of 24 hours, or an event on the stated day that lasts for the whole of the opening hours, operating hours, working hours, etc. of a service provider), a maximum number of permissible key shares during the event.

By way of example, the context may be based on default values provided by the app 220 and/or the first backend server 204. In a step 366, the app 220 requests a signature for the provided context. The requesting can comprise requesting a user authentication to approve the context. By way of example, the requesting may be directed to a secure memory of a terminal on which the customer app 220 is installed.

In a step 368, the customer app 220 sends context and signature to the first backend server 204 (the customer app 220 is no longer involved in other routines). In a corresponding step 304 (method 300 in FIG. 3A), the event-related context is received in the first backend server 204. In a step 306, the backend server 204 provides the received context for a specific (individual) event. The context for the event is not restricted to the received context, received values for the sharing restriction, etc., but can comprise other or further event-related context, for example an event ID, a status of the event, etc.

In a step 308, which can take place before, after or concurrently with step 306, the first backend server 204 sends a request to register the specific event to the second backend server 206. The request can comprise context for the event to be registered, in particular a sharing restriction as described herein. In a corresponding step 342 in method 340 in FIG. 3B, the second backend server receives the request. In a step 344, the server 206 registers the event. By way of example, this can comprise saving received context, including individually prescribed values for the sharing restriction, etc.

In a step 382 in the method 380 in FIG. 3D, the employee app 224 sends a request for key sharing to the first backend server 204. In a corresponding step 310 (method 300 in FIG. 3A), the first backend server 204 receives the request. In response to receiving the request, the backend server 204 checks the current or present context of the digital key of the SBFD service 228 hosted by the backend server 204 in a step 312. The context includes the context previously provided in step 306, including a sharing restriction that may have been prescribed individually for the event.

The checking comprises checking the sharing restriction and in particular whether the requested key sharing is permissible in view of the sharing restriction (as set for the event), i.e., is covered by the customer's approval. The check may have a negative outcome if the time of the request is outside the time window defined for the event and/or if the maximum number of shares for the event has been reached.

If the check has a negative outcome, a corresponding acknowledgement is sent to the employee app 224 and key sharing is not progressed, i.e., no sharing identifier is generated. This would also terminate the method 300. This is indicated by a step 314 in FIG. 3A, in which the first backend server 204 ascertains for example that the event that is being checked has finished, for example, an end time is in the past, a duration has elapsed, etc. Then, in a step 316, the first backend server 204 sets the sharing restriction to zero; more specifically, a limit or a maximum number of permissible key shares during the event is set to the value zero. If an event status pertains to the context, this status can be set to “FINISHED” or the like.

If the check in step 312 is positive, a sharing identifier can be generated (in a CCC context) and sent to the employee app 224. In a step 318, the first backend server 204 sends such an acknowledgement for the request received in step 310 to the employee app 224.

In a step 384 in method 380 in FIG. 3D, the employee app 224 receives the acknowledgement from the first backend server 204. If the acknowledgement contains the requested sharing identifier, key sharing can be continued by calling the sharing identifier. If the acknowledgement contains an indication that key sharing is not possible, key sharing ends, i.e., the method 380 would be terminated at this juncture.

In a step 320 (method 300 in FIG. 3A), a sharing identifier is received in the first backend server, for example, as part of an inherently known routine for key sharing. In a step 322, the first backend server 204 then checks whether the sharing identifier corresponds to a sharing identifier (i.e., is known) that is associated with a current or present, i.e., currently proceeding, event (for example, an event with the status “ACTIVE” or the like), that is to say not, for instance, an event whose time window has already expired, or an event that has already finished (in this case the sharing identifier corresponding to the received sharing identifier might already have been erased).

Depending on a result of the check, the first backend server 204 allows key sharing to continue or terminates key sharing. The latter is indicated in dots by step 324. If the result of the check is negative, a corresponding indication can thus be sent to the employee app 224. This would terminate the method 300 at this juncture.

The negative acknowledgement is received in the employee app 224, and steps 382 and 384 in method 380 in FIG. 3D would take place accordingly as described above, i.e., the method 380 would also be terminated at this juncture.

In a step 346 in method 340 in FIG. 3B, as part of the key sharing in progress, the key tracking server 206 receives a request concerning tracking (key tracking) of a key shared from the digital key. In a step 348, the key tracking server 206 then checks a sharing restriction associated with the event registered in step 344. This can involve a check to determine whether the event is ongoing, i.e., has an active status or the like, and/or can involve a check to determine whether the maximum number of permissible key shares for the event has been reached. If the result of the checking is positive, key sharing continues in an inherently known manner. If the result of the checking is negative, as indicated in dots by a step 350, the key tracking server 206 terminates key sharing, e.g., by sending an appropriate indication to the first backend server 204. This also terminates the method 340 in the key tracking server 206 at this juncture.

In a step 386 in method 380 in FIG. 3D, the employee app 224 sends a request to finish the event to the first backend server 204. In a corresponding step 326, the first backend server 204 receives the request. In a step 328, the first backend server 204 then terminates every currently uncalled sharing identifier, if present, and, in a parallel step 330, terminates the (and any other) shared key that has arisen from key sharing. In a step 332, the first backend server 204 sends an acknowledgement concerning successful finishing of the event to the employee app 224. This terminates the method 300 in FIG. 3A.

In a corresponding step 388, the acknowledgement is received by the employee app 224. The employee app 224 then terminates the procedure in a step 390, i.e., the method 380 in FIG. 3D ends.

The key tracking server 206 receives a request to terminate key tracking from the central key tracking server 204. The key tracking server 206 then terminates key tracking in a step 352, and this ends the method 340 in FIG. 3B.

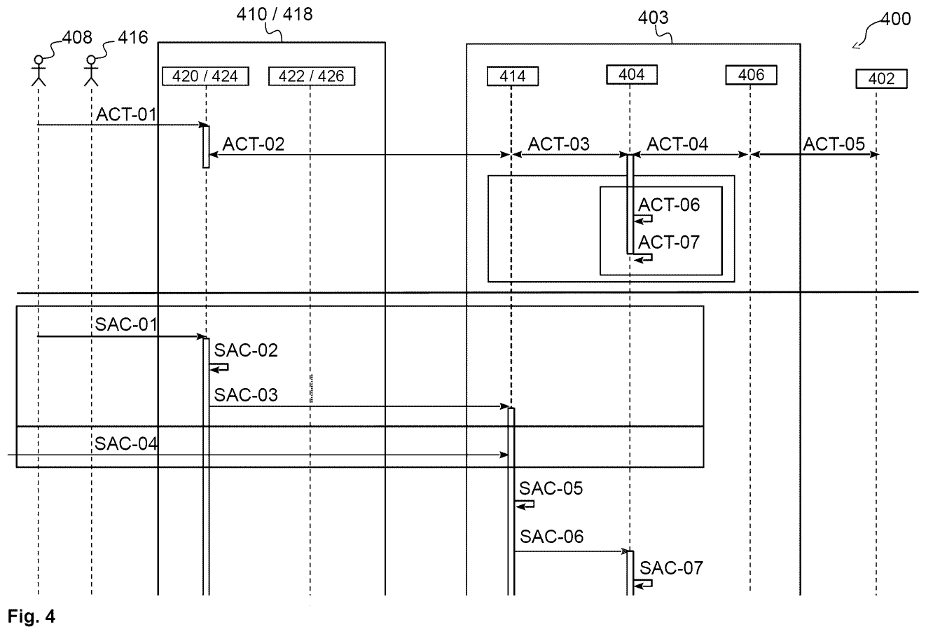

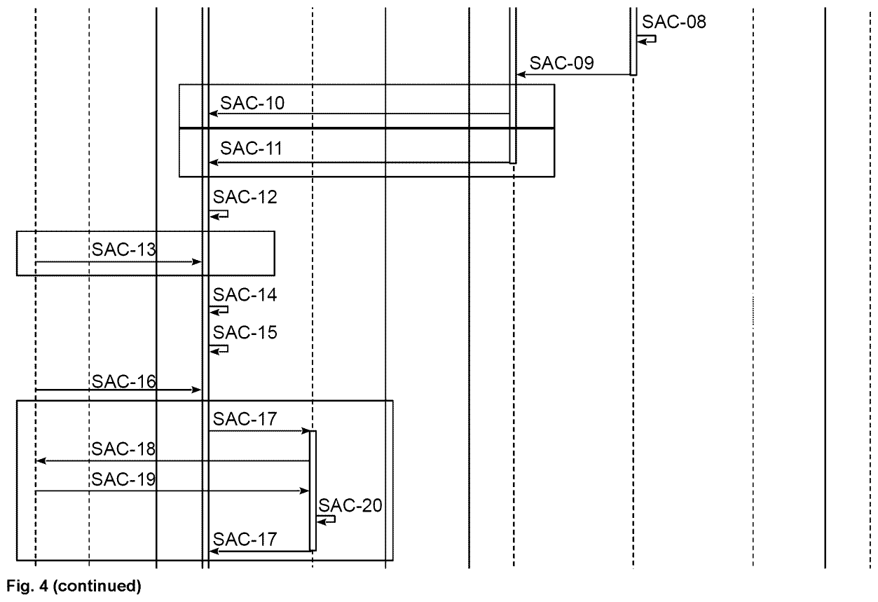

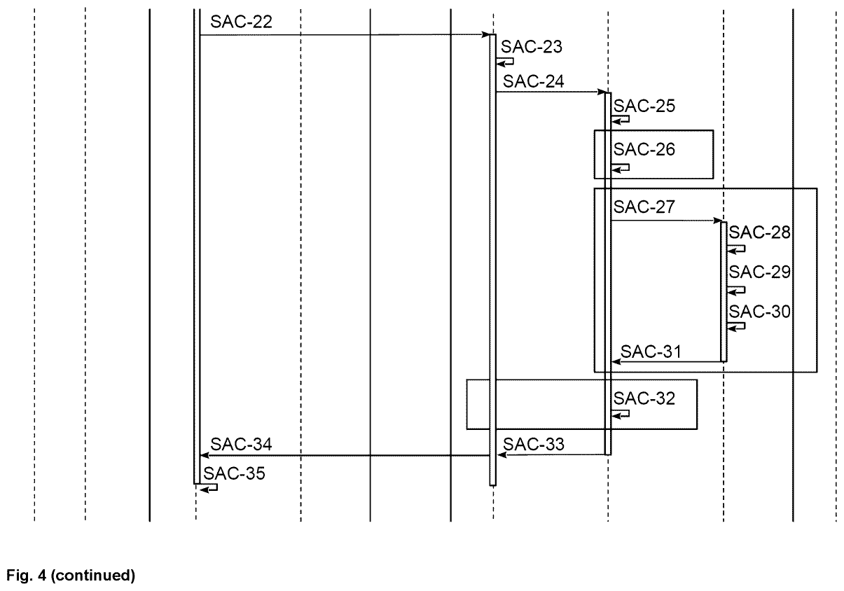

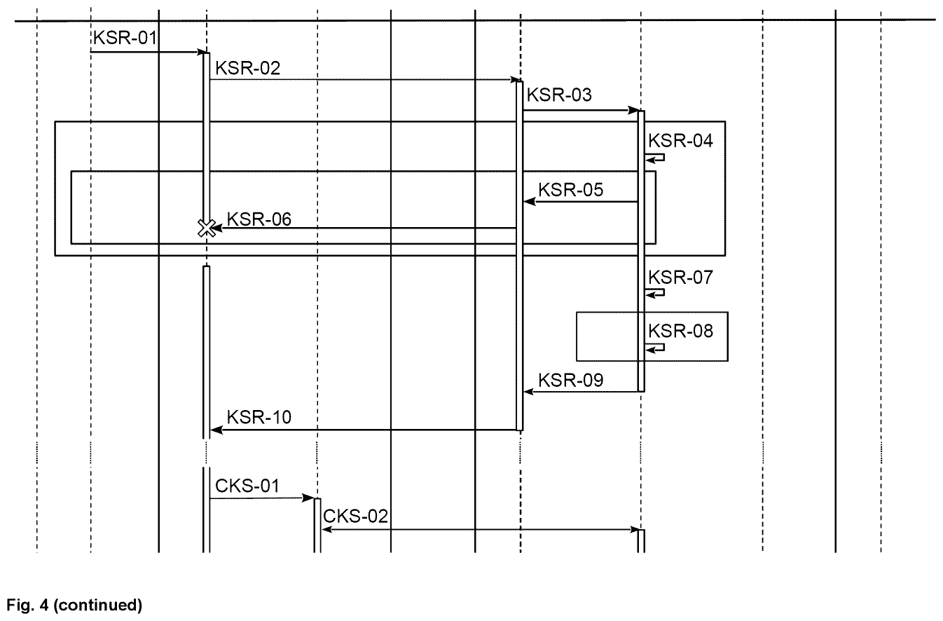

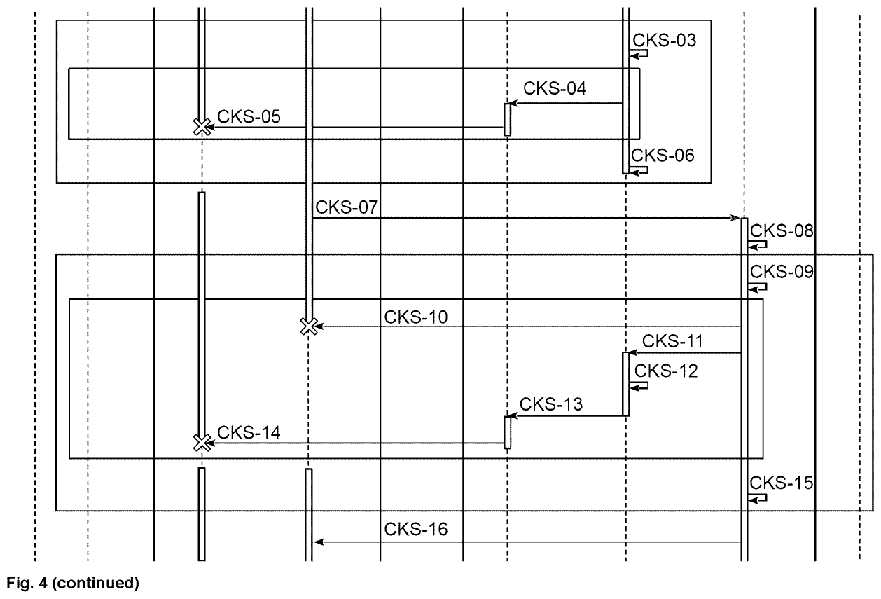

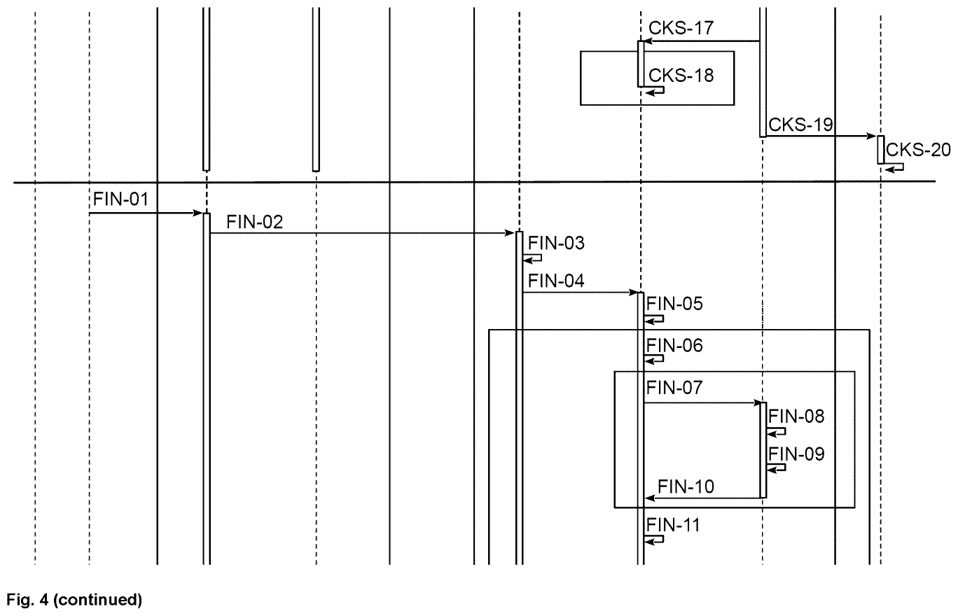

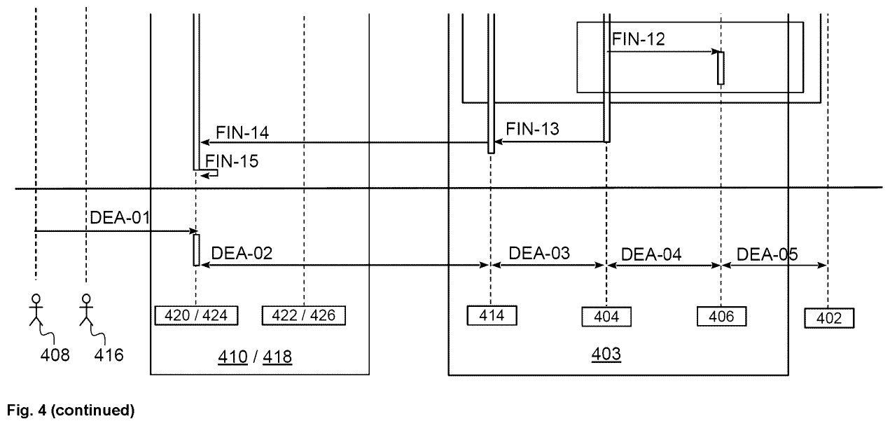

FIG. 4 uses a schematic sequence diagram to illustrate a further exemplary embodiment of a method 400 for sharing a digital key. The system comprises a motor vehicle 402 and, in a backend 403, an SBFD 404, which in the present example is hosted by a central vehicle manufacturer server (in other examples the SBFD can also be hosted by a third party, for example a service provider itself), a key tracking server (KTS) 406 and a service provider server (SPS) 414. The system 400 also comprises a terminal 410 of a keeper 408 of the vehicle 402. The terminal 410 comprises a customer app 420 and an actuator 422 that indicates an operating system/framework and a secure element of the terminal 410. The actuator 422 is usually referred to only as the “secure element 422” below for the sake of clarity. The system 400 furthermore comprises a terminal 418 of an employee 416 of a service provider. The terminal 418 comprises an employee app 424 and an actuator 426 that indicates an operating system/framework and a secure element 426 of the terminal 418. The actuator 426 is usually referred to only as the “secure element 426” below for the sake of clarity.

For reasons of clarity, only one terminal is indicated in FIG. 4, which terminal alternatively either assumes the role of the terminal 410 with the app 420 and the secure element 422 or assumes the role of the terminal 418 with the service app 424 and the secure element 426.

By way of illustration, the method 400 implements (in particular delegated, for example, server based) sharing of a digital key with a dynamic sharing restriction that can be set individually for a specific event (or a specific process, appointment, occasion, a specific gathering, etc.).

In general, a (sharing) limit or restriction is arranged, i.e., provided, supported, maintained during the method, configured, written, read, etc., for a given digital key (for example, a server based key), for example, by providing for appropriate parameters, variables, data fields, for example, in a TLV format, etc. The sharing restriction constrains or limits key sharing, for example, such that key sharing is restricted to the duration of an event and/or such that key sharing is possible only up to a maximum number of key shares.

Accordingly, the sharing restriction can comprise one or more parameters, one or more variables, tags, etc. The sharing restriction may be dynamic in the sense that it can be individually fixed for a type of event and/or an event, and/or in the sense that a value of the sharing restriction (for instance a remaining limit) can be dynamically adjusted, set or updated before or over the duration of an event.

Typical use cases for scenarios as illustrated by method 400 in FIG. 4 are, for example, key shares for SBFD services. As discussed in detail elsewhere herein, it is assumed that an SBFD service will be activated once and then remain active for a longer period of time, e.g., while a multi-year (or perpetual) service contract with the service provider is in place. The vehicle keeper (owner key) sees the service in the vehicle 402, the customer app (e.g., vehicle companion app) 420 and/or in a wallet of the terminal 410 while the contract is active, appointments are regularly made, etc.

Where applicable, the sharing restriction can be dynamically updated, individually adjusted, etc., by an authorized vehicle user (e.g., by means of a digital owner key or admin key). The sharing restriction can additionally or alternatively be set, updated or adjusted by the system that supports the digital key (backend 403, vehicle 402, apps 420, 424, etc.), for example, by specifying a default value, an initial limit, etc., during setup of the SBFD service and/or booking of a specific appointment. The sharing restriction can additionally or alternatively be prescribed, modified or adjusted by authorized third parties, for example, by a hotline of the service provider, the vehicle manufacturer, etc.

The sharing restriction may be linked or can be linked to a specific event (e.g., a workshop appointment), for example, by being handed down, etc. If the event has finished or is over, the sharing or release limit for this event is set to zero, set to an invalid or undefined value, or otherwise set so that no further key shares can be performed for this event.

The routine begins in steps ACT-01-ACT-07 with a service activation (in a CCC scenario). In this case, the customer 408 of the service provider or keeper 408 of the vehicle 402 performs a service activation for a (SBFD) service in order to permit key sharing for employees of the service provider who are working on the vehicle 402.

In step ACT-01, the customer 408 books the service by means of the application or customer app 420 on their terminal 406. The application 420 may be an application that the vehicle manufacturer provides for key management concerning the vehicle 402, or an application of the service provider that the customer 408 also uses to book an appointment. In any case, the application 420 requires a permission to manage digital keys (for the vehicle 402) on the terminal 410. The service (with a technical specification as an SBFD service) can be booked automatically when a contract is concluded, may be part of the scope of a contract, etc. The service may be included e.g. as an option in a contract of sale when the vehicle 402 is purchased, or can be purchased separately.

In steps ACT-02, ACT-03, ACT-04 and ACT-05, a service activation protocol is executed between the application 420 and the service provider server 414, between the service provider server 414 and the central vehicle manufacturer server or SBFD 404, the SBFD or central vehicle manufacturer server 404 and the key tracking server 406, and between the key tracking server 406 and the vehicle 402. The service activation is only indicated here, the details being familiar to those skilled in the art.

Steps ACT-06-ACT-07 concern setting an initial sharing restriction related to the SBFD service, that is to say without a specific appointment booking. In other words, the initial sharing restriction is set independently of an event. Initial, not specifically event-related values can be predefined for time-oriented statements or a maximum number of permissible key shares. The value of this maximum number can be set to zero, for example. A suitable value for the sharing restriction is updated or prescribed in another, separate process, preferably as part of an appointment booking or agreement for a future service appointment.

However, steps ACT-06-ACT-07 can also be considered optional. In one exemplary embodiment, these steps are performed only if the system requires the sharing restriction to be set while the SBFD service is being set up. The following is set in step ACT-06: A number of permissible key shares, a permissible instance (from which requests for key sharing that are sent are accepted), an expiration or expiry timestamp. In step ACT-07, trigger logic for key sharing is provided based on the initially or originally set values.

After the service activation has been performed, the customer has a key element (icon, etc.), which represents the activated service, in a wallet in the terminal 410 and also in the vehicle 402.

Steps SAC-01-SAC-35 concern the sharing restriction being adjusted (or fine-tuned, configured or set) by the customer 408 (or a hotline or other instance). In this case, the customer makes a booking or performs another action, related to a specific event, that requires the sharing restriction to be set (for example, extending a duration of the event that was initially set to zero, or increasing the maximum number of key shares from an initial value of zero). For a high level of security, an authorized digital key must sign the customer's approval for the adjusted values (for example, a digital owner key or administrator key).

Steps SAC-01-SAC-03 concern a first alternative in which a trigger for adjusting the original values or initial values comes from the customer app 420. In step SAC-01, the customer 408 performs an event-related action in the app 420 that is linked to an adjustment of the initial values. By way of example, the customer 408 books an appointment with a workshop in the app 420. In step SAC-02, the following parameters are set: a service provider ID (“identification number” or “identifier”), a service ID, an event ID (this may have been taken from a context), a “from” timestamp, a “to” timestamp, a number of permissible key shares, and other parameters where applicable. In step SAC-03, a request to dynamically set the sharing restriction is sent to the service provider server 414. The request contains the parameters described above.

Step SAC-04 describes a second alternative, in which a trigger for adjusting or setting the initial values comes from a backend (for example, but not only, from the backend 403), for example, when the customer makes a booking via a website, a hotline, or in another way. For some specific examples, the customer books a workshop appointment via a website provided by the vehicle manufacturer, a service provider website, or a hotline. In step SAC-04, the applicable request reaches the service provider server 414. The request contains the parameters described above in step SAC-02.

In a step SAC-05, the service provider server 414 performs a general check on or verification of the received request, for example, against the service contract, a list of available appointments, etc. In a step SAC-06, the service provider server 414 forwards the request to the central vehicle manufacturer server 404, more specifically to the SBFD (hosted by the vehicle manufacturer or a third party). The central vehicle manufacturer server performs a general check on the request in a step SAC-07. In a step SAC-08, the SBFD or the central vehicle manufacturer server 404 creates a TLV (Tag Length Value) structure for a request for approval for key sharing as part of the service. The structure contains a generated session ID, a service provider ID, a service ID, an event ID, a “from” timestamp, a “to” timestamp, data specific to the use case, a statement indicating that a user authentication is required, an ID of the digital key in question, a number of permissible key shares. In addition, the central vehicle manufacturer server 404 sets a timeout.

In a step SAC-09, the central vehicle manufacturer server 404 returns the TLV structure for the request for approval for key sharing as part of the service to the service provider server 414. If the trigger has been received from the customer app 420 (steps SAC-01-SAC-03 above), the service provider server 414 returns the TLV structure for the request for approval for key sharing as part of the service to the customer app 420 in a step SAC-10. If the trigger has alternatively been received from the backend (step SAC-04 above; the backend concerns the service, the vehicle manufacturer, or a hotline), the service provider server 414 sends a push notification of the content that dynamic setting of the sharing restriction is required to the customer app 420 in an alternative step SAC-11 to step SAC-10. The notification contains the data described above for step SAC-08.

In a step SAC-12, the customer app 420 displays the request. The display comprises information about the service provider, the event, the “from” timestamp, the “to” timestamp and/or a duration, and also the number of permissible key shares. In an optional step SAC-13, the customer 408 can set additional parameters. In a step SAC-14, the customer app 420 determines a signature key to be applied. In a step SAC-15, the customer app shows a summary of how to set the dynamic sharing restriction. By way of example, the summary can comprise information concerning the vehicle, a purpose of the event, a duration, etc.

In a step SAC-16, the customer 408 confirms the process. Steps SAC-17-SAC-21 concern a user approval for dynamically setting the sharing restriction. In step SAC-17, the customer app 420 sends a request for signing (for example, “signing of any data”, known as such in a CCC context, but other signing methods are also conceivable) for approval of the TLV data with user authentication to the secure element 422 of the terminal 410. In a step SAC-18, a user authentication is required by the customer 408. Step SAC-18 is shown in simplified form in FIG. 4. As a rule, an operating system or framework of the terminal 410 will request the user authentication, which can include confirmation by the user 408 on the hardware side, for example by pressing a button on the device 410 that is connected on the hardware side to the secure element and thus cannot be manipulated on the software side outside the secure element.

In step SAC-19, the customer 408 performs the required user authentication. In a step SAC-20, the secure element 422 signs the data with the digital key. In a step SAC-21, the secure element 422 returns the signature to the customer app 420.

In a step SAC-22, the customer app 420 sends a request (“SIGN Response” according to the CCC) to confirm that the dynamically configurable sharing restriction has been set to the service provider server 414. In a step SAC-23, the service provider server 414 performs a general check on the received request. In a step SAC-24, the service provider server 414 forwards the request to the central vehicle manufacturer server 404.

In a step SAC-25, the central vehicle manufacturer server 404 performs a general check on the request against the TLV data for a request for approval for key sharing as part of the service, whether a user authentication has been performed, etc. The step SAC-26 concerns checking the user approval for setting the dynamic sharing restriction. In step SAC-26, the signature for the data is checked. This comprises checking a key ID, a user authentication, etc.

Steps SAC-27-SAC-31 are optional. They entail the key tracking server 406 being involved for additional security and enforcing the sharing restriction. In step SAC-27, the central vehicle manufacturer server 404 sends a request for event registration to the key tracking server 406. The request contains information about the service, the dynamic sharing restriction that is set, the signature, etc. In step SAC-28, the key tracking server 406 performs a general check on the request, i.e., checks the origin of the call (service provider) against the supplied information, a syntax, etc.

In a step SAC-29, the key tracking server 406 checks the signature for the data. By way of example, a signature key can be checked, more specifically the status and role of the signature key, e.g. must a role (for example, “owner” or “admin”) of the signature key be able to confirm the event. In addition or alternatively, it is possible to check for example whether there is an explicit user authentication, assuming that release necessarily requires a user authentication, since rights are granted (increase of the sharing restriction).

In a step SAC-30, the key tracking server 406 registers the event with the following data: service provider ID, service ID, event ID, number of permissible key shares, “from/to” timestamp, “ACTIVE” event status. In a step SAC-31, the key tracking server 406 returns an acknowledgement of successful registration to the central vehicle manufacturer server 404.

Step SAC-32 also concerns setting the dynamic sharing restriction individually for the booked event. The central vehicle manufacturer server 404 updates the configuration of the SBFD service in step SAC-32, an event with the following data being added: service provider ID, service ID, event ID, number of permissible key shares, time frame (“from/to” timestamp), “ACTIVE” event status. In a step SAC-33, the central vehicle manufacturer server 404 returns an acknowledgement of successful confirmation of the dynamic sharing restriction to the customer app 420. In a step SAC-35, the customer app 420 updates a user interface accordingly.

The process comprising steps KSR-01-KSR-10 and CKS-01-CKS-20 concerns a request for key sharing. Some of the routines are shown in simplified form, the focus is on additions to inherently known routines, the additions concerning inventive key sharing.

In step KSR-01, the employee 416 requests key sharing for the vehicle 402 using the service app 424. In a step KSR-02, the service app 424 sends a request for key sharing for the vehicle 402 to the service provider server 414. The request can include a VIN (Vehicle Identification Number), inter alia. In step KSR-03, the service provider server 414 sends a request for a sharing URL with a user-friendly name (friendly name) for the digital key to the central vehicle manufacturer server 404.

Steps KSR-04-KSR-06 concern initiating key sharing. In step KSR-04, the central vehicle manufacturer server 404 checks or examines the request against events with the status “ACTIVE” for the current timestamp. Steps KSR-05-KSR-06 concern a routine in which approval has not been obtained, the event is not active or there are no key shares left. In step KSR-05, the central vehicle manufacturer server 404 returns an acknowledgement of the content that the approval status is negative to the service provider server 414. In a step KSR-06, the service provider server 414 returns an acknowledgement of the content that key sharing is not possible because approval has not been obtained and/or there is no active event and/or because there are no key shares left to the service app 424. This ends the key sharing routine at this juncture.

However, if the result of the check in step KSR-04 is positive, the central vehicle manufacturer server 404 generates a sharing URL in step KSR-07 and saves the sharing URL and also the user-friendly name of the digital key. Step KSR-08 again concerns the inventive dynamic sharing restriction and in particular tracking of the key shares in the central vehicle manufacturer server 404. In step KSR-08, the central vehicle manufacturer server 404 updates the event by adding the sharing URL and setting the status of the sharing URL to “GENERATED” or the like. In step KSR-09, the central vehicle manufacturer server 404 returns the sharing URL to the service provider server 414. In step KSR-10, the service provider server 414 returns the sharing URL and parameters for the present use case to the service app 424.

In the subsequent steps CKS-01-CKS-02, the receiver device for the purposes of key sharing, i.e., the terminal 418 of the employee 416, initiates the actual key sharing. In step CKS-01, the service app 424 calls the sharing URL. The call goes to the secure element 426 of the terminal 418. Step CKS-02 represents a routine for sharing a friend key (so-called according to the CCC) between the secure element 426 and the central vehicle manufacturer server 404.

Steps CKS-03-CKS-06 concern a first check on the inventive dynamic sharing restriction during key sharing. In step CKS-03, the central vehicle manufacturer server 404 checks or examines whether the sharing URL is known. The sharing URL must be saved in association with an active event. Steps CKS-04-CKS-05 concern a branch in the routine in which the sharing URL is not found. In step CKS-04, the central vehicle manufacturer server 404 sends an event notification to the service provider server 414 relating to the content that the sharing URL is not known. In a step CKS-05, the service provider server 414 reports to the service app 424 that key sharing is not possible. This ends the key sharing routine at this juncture. If, on the other hand, the sharing URL is found in step CKS-03, step CKS-06 takes place, which again concerns tracking the key shares in the central vehicle manufacturer server 404. More specifically, the central vehicle manufacturer server 404 updates the event in step CKS-06, the status of the sharing URL being set to “SHARED” or the like.

In a step CKS-07, the secure element 426 sends a request to the key tracking server 406 as part of the CCC “friend” key sharing. More specifically, the request concerns a key tracking request with a TLV structure 0x7F38. In a step CKS-08, the key tracking server 406 verifies the key tracking request in respect of the SBFD signature.

Steps CKS-09-CKS-15 again concern the inventive dynamic sharing restriction and in particular a sequence that, to increase security, involves the key tracking server 406 in order to enforce a policy for key sharing. This makes key sharing robust against manipulation attempts by the SBFD. In step CKS-09, the key tracking server 406 checks whether the event is active and checks how many shares have taken place compared to the maximum number of shares.

Steps CKS-10-CKS-14 concern a branch in the sequence in which approval has not been obtained, the event is not active or there are no key shares left. In step CKS-10, the key tracking server 406 sends an acknowledgement to the terminal 418 with the secure element 426 as part of the CCC “friend” key sharing. More specifically, the acknowledgement is a key tracking acknowledgement with the content that key sharing is not possible because approval has not been obtained and/or there is no active event and/or there are no key shares left. A component in the terminal 418 processes the return data and passes on some of them (for example, in the form of APDU commands) to the secure element 426; for example, the secure element 426 could receive a command to terminate or erase the endpoint that was not able to be tracked.

In step CKS-11, the key tracking server 406 sends an event notification of the content that key sharing is not possible because approval has not been obtained and/or there is no active event and/or there are no key shares left to the central vehicle manufacturer server 404.

In a step CKS-12, which again concerns tracking key shares in the central vehicle manufacturer server 404, the central vehicle manufacturer server 404 updates the event in question, the status of the sharing URL being set to “RESTRICTION VIOLATION—FAILED” or the like and the status of the event being set to “INACTIVE/RESTRICTION VIOLATION—FAILED” or the like.

In a step CKS-13, the central vehicle manufacturer server 404 returns an acknowledgement of the content that an approval status is negative to the service provider server 414. In a step CKS-14, the service provider server 414 returns an acknowledgement of the content that key sharing is not possible because approval has not been obtained and/or there is no active event and/or there are no key shares left to the service app 424. This ends the key sharing routine at this juncture.

However, if the result of the check in step CKS-09 is positive, the key tracking server 406 updates the event in a step CKS-15, a current state of a number of shares being updated.

In a step CKS-16, the key tracking server 406 returns an acknowledgement to the terminal 418 with the secure element 426 as part of the CCC “friend” key sharing routine. More specifically, the acknowledgement is a key tracking acknowledgement with a KTS affirmation, encrypted data for a confidential mailbox, etc. The rest of the routine in the terminal 418 is known as such.

In a step CKS-17, the key tracking server 406 sends an event notification to the central vehicle manufacturer server 404 relating to the content that a new key is being tracked. Step CKS-18 again concerns the inventive dynamic sharing restriction and in particular the tracking of key shares in the central vehicle manufacturer server 404. In step CKS-18, the central vehicle manufacturer server 404 updates the event in question by setting the status of the sharing URL to “SHARING PERFORMED” or the like.

In a step CKS-19, the key tracking server 406 sends attestation data of the key to the vehicle 402. In a step CKS-20, in which the digital key is made known to the vehicle 402, the vehicle 402 verifies the attestation data and puts the data into effect.

Steps FIN-01-FIN-15 concern finishing the event. The representation of some processes in FIG. 4 is simplified. The employee 416 has finished work on the vehicle 402 and sets the event to “finished” or the like. All currently existing key shares are then terminated and the dynamic sharing restriction for remaining key shares is effectively set to zero for the event.

The sequence in FIG. 4 describes a certain way of finishing an event. In general, an event can be finished, aborted, etc., for various reasons. By way of example, a customer could also cancel an appointment. All these different reasons can lead to slightly altered routines each time, but all of them are intended to be included in the invention.

In step FIN-01, the employee 416 performs an operator control operation in the employee app 424 on the terminal 418 (which could be a mobile device, but also a service terminal, etc.), the effect of which is that the event has finished. In a step FIN-02, the employee app 424 sends a request concerning finishing the event to the service provider server 414. The request can include an event ID, inter alia. In a step FIN-03, the service provider server 414 performs a general verification of the request. In a step FIN-04, the service provider server 414 forwards the request to the central vehicle manufacturer server 404.

In a step FIN-05, the central vehicle manufacturer server 404 performs a general check on the request. Steps FIN-06-FIN-12 concern the inventive dynamic sharing restriction. In step FIN-06, the central vehicle manufacturer server 404 updates the configuration of the SBFD service: The status of the event is set to “INACTIVE/FINISHED” or the like.

Steps FIN-07-FIN-10 are optional and concern a sequence that, to increase security, involves the key tracking server 406 in order to enforce a policy for key sharing. In step FIN-07, the central vehicle manufacturer server 404 sends a request concerning aborting or ending the event. The request can include the event ID, inter alia. In a step FIN-08, the key tracking server 406 checks the request, i.e., checks the origin of the call (service provider) against the supplied information, a syntax, etc. In step FIN-09, the key tracking server 406 updates the event, the status of the event being set to “INACTIVE/FINISHED” or the like. This results in future key tracking becoming inadmissible.

In step FIN-10, the key tracking server 406 provides an acknowledgement of successful ending of the event to the central vehicle manufacturer server 404. In a step FIN-11, the central vehicle manufacturer server 404 terminates sharing URLs for the event that have not yet been called. Step FIN-12 is executed in a loop, specifically for each shared key for the event. In step FIN-12, a command is given to the key tracking server to terminate the applicable key. This causes the key to be terminated and all affected parties to be notified (devices, SBODs and SBFDs that hold the digital key with visibility permissions).

In a step FIN-13, the central vehicle manufacturer server 404 provides an acknowledgement concerning successful finishing of the event to the service provider server 414. In a step FIN-14, the service provider server 414 provides an acknowledgement concerning successful finishing of the event to the employee app 424. In a step FIN-15, the employee app 424 updates a user interface accordingly.

Steps DEA-01-DEA-05 concern deactivating the service. The description is simplified here, the details being known to those skilled in the art. In step DEA-01, the customer or vehicle keeper 408 uses the customer app 420 on their terminal 406 to initiate a deactivation of the service (this can be done in various ways). In steps DEA-02, DEA-03, DEA-04 and DEA-05, a service deactivation protocol is performed between each of the app 420 on the terminal 406 of the vehicle keeper 408 and the service provider server 414, the service provider server 414 and the central vehicle manufacturer server 404, the central vehicle manufacturer server 404 and the key tracking server 406, and also the key tracking server 406 and the vehicle 402. This results in the service key element in the wallet of the terminal 406 and in the vehicle 402 being removed.

Embodiments of the invention involve a context of a digital key or a service linked thereto in a decision as to whether or not further key sharing is allowed. In particular, a current context (one that is present at the time of the request for key sharing) can be checked to establish whether there is an event (an event, a job, an appointment, etc.). Key sharing is permissible only during an event, for example, during an appointment in a workshop.

In other words, key sharing is permissible only on an event-related basis and this can be ensured by means of an appropriate sharing restriction that pertains to the context that is being checked. In some embodiments of the invention, the sharing restriction defines a temporal extent of an event by means of “from” and “to” timestamps or by means of a start time and a duration, etc. (in some embodiments, an event could even be defined exclusively by a temporal extent). If such a definition of a temporal extent or sharing restriction exists, this is interpreted by the system to mean that key sharing is generally permissible only during the event, i.e., while the event is ongoing.

In some embodiments, key sharing is possible for the applicable (SBFD) service indefinitely for the duration of an event. In other embodiments, event-related key sharing is permissible only up to a limit or a specified (maximum) number of key shares. In some of these embodiments, the limit or number may have been firmly specified by the system. In other embodiments, the system supports such a limit on a service-related and/or event-related basis, and the limit may then be dynamic, i.e., it can be set per event, decremented for each effected key sharing, etc.

In some embodiments, an event-related sharing restriction can therefore define timestamps and the maximum permissible number of key shares for each individual event, and this sharing restriction can be displayed to the customer on their terminal, in a vehicle companion app, service provider app or other customer app. This sharing restriction is checked continually during the event, i.e., whenever key sharing is requisitioned, and can be set to zero for example at the end of the event (this can also be displayed in the customer app). This behavior for delegated key sharing is transparent to both the customer and the service provider and is therefore suitable for building trust.

Embodiments of the invention propose further technical measures to minimize security holes. By way of example, it is thus possible for a double context check to take place, i.e., once when key sharing is requisitioned, i.e., before a sharing URL is called, and again when the sharing URL is called. This increases security because some time may elapse between requisitioning and a sharing URL being called, and a recheck can thus rule out abuse as far as possible even in such situations.

Other embodiments suggest also involving the key tracking server (KTS). This can also provide additional security, where applicable as a third security mechanism, and takes into account situations in which the SBFD might be corrupt. This may be relevant, for example, if a service provider server and a central vehicle manufacturer server are operated by a common operator, in a common setup, etc.

Embodiments of the invention are very explicitly based on a defined temporal extent of an event. By way of example, there can be provision for a service provider (also in its own interest) to explicitly declare work finished, and from this point on the system will ensure that no further key sharing is possible, that no further sharing URLs that have already been created can be successfully called, and that remaining keys are voided. The same automatically also applies when the end of the event or appointment is reached. If all shared keys have been erased, then between appointments there are no keys for the vehicle with the service provider, except at most from the SBFD service itself (in some configurations), which does not allow direct access to the vehicle, however.

If key sharing is now possible only on an event-related basis, this closes security holes in setups with lengthy service activations, which are preferred by many customers, however. This increases convenience while maintaining security requirements, i.e., abuse during delegated key sharing is hampered or prevented. This increases confidence in delegation of key shares to service providers, and quite generally in scenarios involving the handling of digital keys, in particular vehicle keys.

Inventive embodiments are thus suitable for increasing general confidence in techniques for in particular server based key sharing. In general, confidence in the practicability and security of digital vehicle keys, associated key management, etc., is increased, and this is of great importance in view of the increasing prevalence of digital vehicle keys.

Embodiments of the invention are generally applicable for commercial business models in which a customer books work, a service, etc. (or an applicable appointment), places an applicable order, etc., for example, maintenance, repair, washing, cleaning, etc., but also other services such as parking aids (these could involve key sharing being permitted only once per event, for example).

Embodiments of the invention are therefore of commercial interest to vehicle manufacturers, device manufacturers, car sharing providers, third-party providers of services such as breakdown assistance, parking service, etc., and also all applicable Tier 1 suppliers with regard to digital keys, in particular vehicle keys.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 system
102 motor vehicle, vehicle
104 central vehicle manufacturer server
106 key tracking server
108 vehicle keeper, customer
110 vehicle keeper's terminal
112 service provider
114 service provider server
116 employee
118 employee's terminal
120 customer app
122 secure memory
124 employee app
126 secure memory
128 SBFD, SBFD service
130 context
132 event
134 service activation
136 booking process
138 start time
140 end time
142 limit
150 requisition key sharing
152 request key
154 first check
156 request a URL
158 second check
160 registration
162 third check
164 deny the request/requisition
200 system
204 first backend server
206 second backend server
220 customer app
224 employee app
228 SBFD, SBFD service
300 method
302-332 steps of the method
340 method
342-352 steps of the method
360 method
362-368 steps of the method
380 method
382-390 steps of the method
400 method
402 vehicle
403 backend
404 SBFD (in the central vehicle manufacturer server)
406 key tracking server
408 customer
410 customer's terminal
414 service provider server
416 employee
418 employee's terminal
420 customer app
422 operating system (framework)/secure element of the terminal 410
424 employee app
426 operating system (framework)/secure element of the terminal 418
ACT-01-ACT-07 method steps
SAC-01-SAC-035 method steps
KSR-01-KSR-10 method steps
CKS-01-CKS-20 method steps
FIN-01-FIN-15 method steps
DEA-01-DEA-05 method steps

What is claimed is:

1. A method for sharing a digital key, the method comprising:
receiving a request for key sharing;
in response to receiving the request, checking a current context of the digital key; and
sending an acknowledgement for the request based on the checking of the current context.

2. The method according to claim 1, wherein the key sharing is restricted to a current event.

3. The method according to claim 1, wherein the context comprises a sharing restriction to restrict the key sharing, and the checking comprises checking the sharing restriction.

4. The method according to claim 3, wherein the sharing restriction comprises a maximum number of permissible key shares for an event.

5. The method according to claim 3, wherein the checking comprises:
determining that an event has finished; and
based on the determining, setting the sharing restriction to zero.

6. The method according to claim 1, further comprising:
receiving event-related context; and
providing an event having the received event-related context.

7. The method according to claim 1, wherein the checking comprises:
receiving a sharing identifier;
in response to receiving the sharing identifier, checking whether the sharing identifier is associated with a current event; and
based on the checking whether the sharing identifier is associated with the current event, selectively terminating the key sharing.

8. The method according to claim 1, further comprising:
receiving a request to finish an event; and
in response to the received request, terminating an uncalled sharing identifier or terminating a shared key that has resulted from the key sharing.

9. A method for sharing a digital key, the method comprising:
receiving a request for registering an event;
receiving a request concerning tracking a key shared from the digital key;
in response to receiving the request concerning tracking the key shared from the digital key, checking a sharing restriction associated with the registered event; and
selectively terminating the key sharing, based on the checking of the sharing restriction.

10. A method for sharing a digital key, the method comprising:
providing event-related context for key sharing;
requesting a signature for the event-related context; and
sending the event-related context and the signature.

11. The method according to claim 10, wherein the event-related context comprises a dynamic sharing restriction defined by at least one of a start time for the event, an end time for the event, a duration of the event, or a maximum number of permissible key shares during the event.

12. The method according to claim 10, wherein the requesting comprises requesting a user authentication in order to approve the event-related context.

13. A method for sharing a digital key, the method comprising:
sending a request for key sharing; and
receiving an acknowledgement for the request, the acknowledgement relating to an event-related sharing restriction for the key sharing.

14. The method according to claim 13, wherein the acknowledgement is received before or after a sharing identifier.

15. A backend server configured to share a digital key, wherein the backend server is configured to receive a request for key sharing; in response to receiving the request, check a current context of the digital key; and send an acknowledgement for the request based on the checking of the current context.

16. A computer program product comprising program code sections, which when executed on a computer, cause the computer to provide event-related context for key sharing, request a signature for the event-related context, and send the event-related context and the signature.

17. A terminal having a secure memory for storing a digital key, the terminal being configured to provide event-related context for key sharing, request a signature for the event-related context, and send the event-related context and the signature.

18. A system for sharing a digital key for a motor vehicle, the system comprising:
the motor vehicle;
at least one backend server operated by a manufacturer of the motor vehicle; and
at least one computer program product supported by the manufacturer of the motor vehicle;
wherein the computer program product is configured to provide event-related context for key sharing, request a signature for the event-related context, and send the event-related context and the signature.
